(19) United States
(12) Patent Application Publication
(10) Pub. No.: US 2009/0267898 A1
(43) Pub. Date: Oct. 29, 2009

(54) INPUT APPARATUS AND CONTROL SYSTEM

(75) Inventors: Kazuyuki Yamamoto, Kanagawa (JP); Hidetoshi Kabasawa, Saitama (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/423,430

(22) Filed: Apr. 14, 2009

(30) Foreign Application Priority Data
Apr. 24, 2008 (JP) P2008-114330

(51) Int. Cl. G09G 5/08

(52) U.S. Cl. 345/158

(57) ABSTRACT

An input apparatus includes: a casing; a sensor module that includes a reference potential and outputs, as a detection signal, a fluctuation of a potential with respect to the reference potential, that corresponds to a movement of the casing; a velocity calculation unit to calculate a pointer velocity value as a velocity value for moving a pointer based on an output of the sensor module; a first execution section to execute a calibration mode as processing for correcting the reference potential; a second execution section to execute an operation mode as processing for moving the pointer on a screen in accordance with the pointer velocity value calculated by the velocity calculation unit; and a switch to switch the execution of the calibration mode to the execution of the operation mode and vise versa in accordance with an input operation from outside.

### CROSS REFERENCES TO RELATED APPLICATIONS

The present application claims priority to that disclosed in Japanese Priority Patent Application JP 2008-114330 filed in the Japan Patent Office on Apr. 24, 2008, the entire contents of which is hereby incorporated by reference.

### BACKGROUND

The present application relates to a 3-dimensional operation input apparatus for operating, for example, a GUI (Graphical User Interface), and a control system therefore.

Pointing devices, particularly a mouse and a touchpad, are used as controllers for GUIs widely used in PCs (Personal Computers). Not just as HIs (Human Interfaces) of PCs as in related art, the GUIs are now starting to be used as an interface for AV equipment and game devices used in living rooms etc. with, for example, televisions as image media. Various pointing devices that a user is capable of operating 3-dimensionally are proposed as controllers for the GUIs of this type (see, for example, Japanese Patent Application Laid-open No. 2001-56743 and Japanese Patent Application Laid-open No. Hei 10-301704; hereinafter, referred to as Patent Documents 1 and 2, respectively).

Patent Document 1 discloses an input apparatus including angular velocity gyroscopes of two axes, that is, two angular velocity sensors. When a user holds the input apparatus in hand and swings it vertically and laterally, for example, the angular velocity sensors detect angular velocities about two orthogonal axes, and a command signal as positional information of a cursor or the like displayed by a display means is generated in accordance with the angular velocities. The command signal is transmitted to a control apparatus, and the control apparatus controls display so that the cursor moves on a screen in response to the command signal.

Patent Document 2 discloses a pen-type input apparatus including three (triaxial) acceleration sensors and three (triaxial) angular velocity sensors (gyro). The pen-type input apparatus calculates movement directions and movement distances thereof by executing various operations based on signals obtained by the three acceleration sensors and three angular velocity sensors.

Incidentally, the input apparatuses of Patent Documents 1 and 2 use gyro sensors and acceleration sensors that detect, instead of directly detecting displacements, inertial amounts using dimensions of displacements obtained by temporally differentiating angular velocities, accelerations, and the like. The angular velocity sensors and the acceleration sensors each output a fluctuation of a potential with respect to a reference potential, that corresponds to a movement of the input apparatus, as a detection signal. Based on the output detection signal, a command signal including, for example, a position, a movement amount, and a movement velocity is generated.

Meanwhile, because the inertial sensors above detect a movement operation of the input apparatus based on the fluctuation of the potential with respect to the reference potential, when the reference potential is deviated, an inconvenience that a cursor moves at a constant velocity or a constant acceleration irrespective of the fact that the input apparatus is stopped is caused. The deviation of the reference potential is caused by, for example, temperature characteristics of piezoelectric devices and analog circuit devices.

To eliminate unintentional movements of the cursor due to the deviation of the reference potential, the reference potential needs to be corrected periodically or unperiodically. For example, U.S. Pat. No. 5,825,350 (hereinafter, referred to as Patent Document 3) discloses a technique in which a reference potential of a gyro sensor is corrected when an output of the gyro sensor is equal to or smaller than a predetermined threshold value.

### SUMMARY

In a calibration method disclosed in Patent Document 3, a calibration is started as long as a certain condition is satisfied during an operation of an input apparatus. Therefore, there are cases where, while a user is moving the input apparatus slowly in one direction at approximately a constant velocity, the correction of the reference potential is executed with an output value of the gyro sensor at this time as a reference. In this case, the cursor moves on its own in a direction opposite to the one direction even when the movement of the input apparatus is stopped, which is inconvenient.

Meanwhile, it is possible to solve the above problem by strictly setting a threshold value for a sensor output that is to be a reference for starting the calibration. However, if the threshold value is set strictly, there is a fear that, due to noises and minute vibrations in the environment, an inconvenience that an operational mode cannot be shifted to a calibration mode even though the input apparatus is not actually operated or is in a static state, may be newly caused.

In view of the circumstances as described above, there is a need for an input apparatus and a control system that are capable of appropriately calibrating a sensor.

According to an embodiment, there is provided an input apparatus including a casing, a sensor module, a velocity calculation unit, a first execution means, a second execution means, and a switch. The sensor module includes a reference potential and outputs, as a detection signal, a fluctuation of a potential with respect to the reference potential, that corresponds to a movement of the casing. The velocity calculation unit calculates a pointer velocity value as a velocity value for moving a pointer based on an output of the sensor module. The first execution means executes a calibration mode as processing for correcting the reference potential. The second execution means executes an operation mode as processing for moving the pointer on a screen in accordance with the pointer velocity value calculated by the velocity calculation unit. The switch switches the execution of the calibration mode to the execution of the operation mode and vise versa in accordance with an input operation from outside.

In an embodiment, due to the provision of the switch that switches the execution of the calibration mode to the execution of the operation mode and vise versa in accordance with the input operation from the outside, it becomes possible to reflect a user's intention of using the input apparatus on a detection of a static state of the input apparatus. Accordingly, the sensor module can be calibrated appropriately.

In the input apparatus according to an embodiment, the sensor module may include an angular velocity sensor to detect an angular velocity in a rotational direction with a first direction as a center axis. Accordingly, detection accuracy of the angular velocity sensor can be improved, and an unintentional movement of the pointer can thus be suppressed.

It should be noted that the sensor module may also include a second angular velocity sensor to detect an angular velocity in a rotational direction with a direction orthogonal to or intersecting the first direction as a center axis, in addition to a first angular velocity sensor to detect the angular velocity in the rotational direction with the first direction as the center axis.

In the input apparatus according to an embodiment, the calibration mode may include a calibration preparation mode. Accordingly, as compared to the case where calibration processing is started immediately after the switch switches the mode to the calibration mode, detection accuracy can be improved.

Examples of the calibration preparation mode include processing of judging a static state of the casing based on the output of the sensor and processing of suspending a start of the calibration until a predetermined time has elapsed since the switch has switched the mode to the calibration mode.

For detecting whether the input apparatus is being used by the user or not, the switch is structured to be capable of carrying out a switch operation in accordance with the input operation from the outside. As one form, the switch can be constituted of a sensor to detect whether the user is holding the input apparatus. As another form, the switch can be constituted of a sensor to detect whether the input apparatus is mounted on a static portion. By executing the calibration mode when the unused state of the input apparatus is detected based on the output of those switches, it becomes possible to carry out highly-accurate sensor calibration processing having excellent reliability.

In the input apparatus according to an embodiment, the sensor module may include an angular velocity sensor to detect an angular velocity in a rotational direction with a first direction as a center axis, and a first acceleration sensor to detect an acceleration in a second direction different from the first direction. Moreover, the input apparatus may further include a second acceleration sensor to detect an acceleration in the first direction.

The acceleration sensor and the angular velocity sensor are each a sensor to output the fluctuation of the potential with respect to the reference potential, that corresponds to the movement of the casing, as a detection signal. Therefore, by executing the calibration mode, outputs of those sensors can be made appropriate. It should be noted that in the calibration mode, both the acceleration sensor and the angular velocity sensor may be calibrated, or either one of the sensors alone may be calibrated.

In the input apparatus according to an embodiment, the switch may be a sensor to detect that the input apparatus has been placed on a support means for supporting the input apparatus when the input apparatus is not used, and the sensor may switch the mode to the calibration mode when detecting that the input apparatus has been placed on the support means.

When the input apparatus is in the unused state, it can be judged that the input apparatus is in the static state. Thus, the structure above enables the sensor calibration processing to be carried out appropriately.

Here, by structuring the input apparatus such that the second direction becomes orthogonal to a vertical direction when the input apparatus is placed on the support means, the first acceleration sensor can be calibrated without being affected by gravity. Further, by structuring the input apparatus such that not only the second direction but also the first direction becomes orthogonal to the vertical direction, both the first and second acceleration sensors can be calibrated.

In the input apparatus according to an embodiment, the casing may include a grip portion, and the switch may be a proximity sensor that is provided at the grip portion and switches the mode to the calibration mode when an output of the proximity sensor corresponds to an output thereof obtained when a user is not holding the grip portion.

When the grip portion of the casing is not held by the user, the input apparatus can be judged as being in the unused state, that is, the static state. Thus, the structure above enables the sensor calibration processing to be carried out appropriately.

The input apparatus according to an embodiment may further include a luminescent display means as a notification means, the first execution means may cause the luminescent display means to emit light in a first luminescence pattern while the calibration mode is being executed, and the second execution means may cause the luminescent display means to emit light in a second luminescence pattern different from the first luminescence pattern while the operation mode is being executed.

Accordingly, the user can visually recognize which of the calibration mode and the operation mode is being executed in the input apparatus based on the luminescence pattern.

The input apparatus according to an embodiment may further include a sound generation means as a notification means, the first execution means may cause the sound generation means to generate sound in a first sound pattern while the calibration mode is being executed, and the second execution means may cause the sound generation means to generate sound in a second sound pattern different from the first sound pattern while the operation mode is being executed.

Accordingly, the user can auditorily recognize which of the calibration mode and the operation mode is being executed in the input apparatus based on the sound pattern.

The input apparatus according to an embodiment may further include a nonvolatile storage section to store a first correction value obtained by executing the calibration mode. Accordingly, it becomes possible to use a previously-corrected reference value of the sensor as a reference value of the sensor at a time the power of the input apparatus is turned on again.

In this case, the first execution means may store, when a difference between a second correction value obtained by newly executing the calibration mode and the first correction value stored in the storage section is equal to or smaller than a first threshold value, the second correction value in the storage section by replacing the first correction value therewith. Accordingly, an erroneous calibration of the sensor can be prevented when the second correction value is an anomalous value.

On the other hand, the first execution means may store, when a second correction value obtained by newly executing the calibration mode is equal to or smaller than a second threshold value, the second correction value in the storage section by replacing the first correction value therewith. Accordingly, it becomes possible to secure an appropriate calibration of the sensor module.

In this case, the first execution means may re-execute the calibration mode when the second correction value exceeds the second threshold value, and the first execution means may store, when a difference between a third correction value obtained by re-executing the calibration mode and the second correction value is equal to or smaller than a third threshold value, one of the second correction value, the third correction value, and a mean value of the second correction value and the third correction value in the storage section by replacing the first correction value therewith. Accordingly, it becomes possible to realize a more appropriate calibration of the sensor module.

Furthermore, the first execution means may cancel the execution of the calibration mode when a magnitude of the detection signal exceeds a fourth threshold value while the calibration mode is being executed. Accordingly, because the sensor module can be prevented from being calibrated in a state where noises including disturbances and the like are incorporated in the input apparatus, the calibration can be made appropriate. Moreover, the execution of the calibration mode can be canceled also when the switch has switched the mode to the operation mode while the calibration mode is being executed. Accordingly, the sensor module can be prevented from being calibrated even though the input apparatus is executing the operation mode, with the result that the calibration can be made appropriate.

According to another embodiment, there is provided a control system including an input apparatus and a control apparatus. The input apparatus includes a casing, a sensor module, a velocity calculation unit, a transmission unit, a first execution means, a second execution means, and a switch. The sensor module includes a reference potential and outputs, as a detection signal, a fluctuation of a potential with respect to the reference potential, that corresponds to a movement of the casing. The velocity calculation unit calculates a pointer velocity value as a velocity value for moving a pointer based on an output of the sensor module. The transmission unit transmits the pointer velocity value calculated by the velocity calculation unit. The first execution means executes a calibration mode as processing for correcting the reference potential. The second execution means executes an operation mode as processing for moving the pointer on a screen in accordance with the pointer velocity value calculated by the velocity calculation unit. The switch switches the execution of the calibration mode to the execution of the operation mode and vise versa in accordance with an input operation from outside. The control apparatus includes a reception means and a display control means. The reception means receives information on the pointer velocity value transmitted from the transmission unit. The display control means controls a display position of the pointer on the screen in accordance with the pointer velocity value received by the reception means.

In an embodiment, due to the provision of the switch that switches the execution of the calibration mode to the execution of the operation mode and vise versa in accordance with the input operation from the outside, it becomes possible to reflect a user's intention of using the input apparatus on a detection of the static state of the input apparatus. Accordingly, the sensor module can be calibrated appropriately.

According to an embodiment, the sensor module can be calibrated appropriately.

Additional features and advantages are described herein, and will be apparent from the following Detailed Description and the figures.

### BRIEF DESCRIPTION OF THE FIGURES

FIG. 1 is a diagram showing a control system according to a first embodiment;

FIG. 2 is a perspective diagram showing an input apparatus according to the first embodiment;

FIG. 3 is a diagram schematically showing an internal structure of the input apparatus;

FIG. 4 is a block diagram showing an electrical structure of the input apparatus;

FIG. 5 is a diagram showing an example of a screen displayed on a display apparatus in the control system;

FIG. 6 is a diagram showing a state where a user is holding the input apparatus;

FIG. 7 are diagrams for illustrating typical examples of ways of moving the input apparatus and ways a pointer moves on the screen accordingly;

FIG. 8 is a perspective diagram showing a sensor module (sensor unit) incorporated in the input apparatus;

FIG. 9 is a flowchart showing an operation of the control system;

FIG. 10 is a flowchart showing an operation of the control system in a case where a control apparatus of the control system carries out main operations;

FIG. 11 is a flowchart showing an operation of the input apparatus regarding a velocity value calculation method according to one embodiment;

FIG. 12 is a diagram for illustrating a basic idea of the velocity value calculation method according to an embodiment;

FIG. 13 are diagrams for illustrating an example of an angular velocity calculation method and a necessity of calibrating a sensor, according to an embodiment;

FIG. 14 is a flowchart showing an example of a sensor calibration method according to an embodiment;

FIG. 15 is a flowchart showing an example of the sensor calibration method according to another embodiment;

FIG. 16 is a flowchart showing an example of the sensor calibration method according to still another embodiment;

FIG. 17 are diagrams showing a schematic structure of an input apparatus according to a second embodiment, in which FIG. 17A is a plan view and FIG. 17B is a side view thereof;

FIG. 18 are diagrams showing an input apparatus and a calibration jig thereof, according to a third embodiment;

FIG. 19 is a perspective diagram showing a modification of a calibration of the input apparatus according to an embodiment; and

FIG. 20 are diagrams showing another modification of the calibration of the input apparatus according to an embodiment, in which FIG. 20A is a perspective diagram thereof and FIG. 20B is a side view showing a position of the input apparatus in a calibration mode.

### DETAILED DESCRIPTION

The present application will be described below in greater detail with reference to the drawings according to an embodiment.

### First Embodiment

### (Control System)

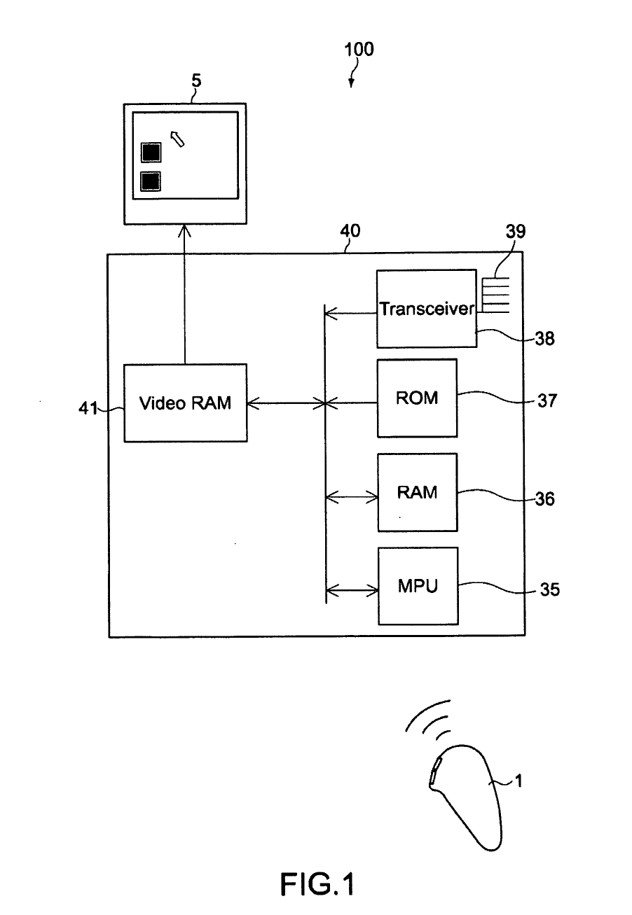

FIG. 1 is a diagram showing a control system according to a first embodiment. A control system 100 includes a display apparatus 5, a control apparatus 40, and an input apparatus 1.

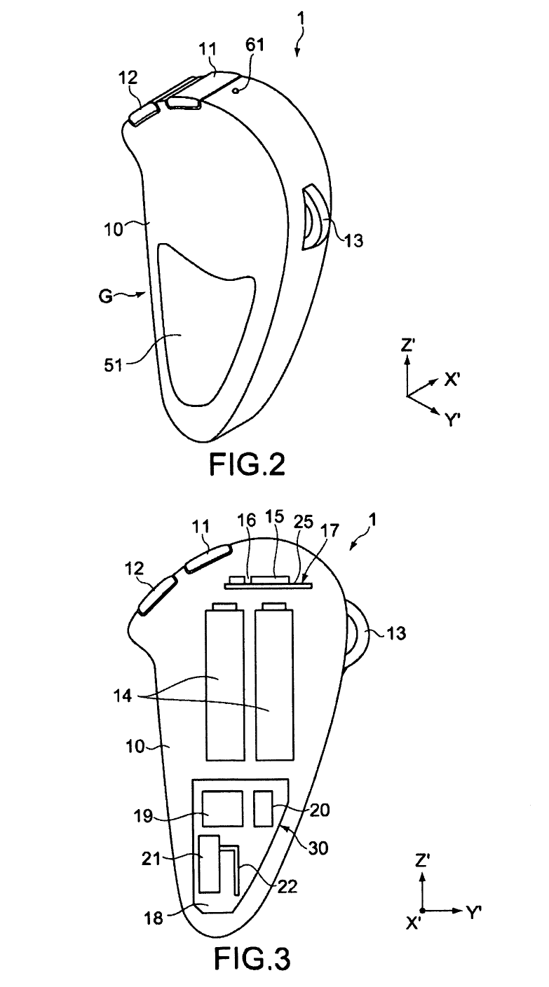

FIG. 2 is a perspective diagram showing the input apparatus 1. The input apparatus 1 is of a size that a user is capable of holding. The input apparatus 1 includes a casing 10 and operation sections including two buttons 11 and 12 provided at an upper portion of the casing 10, a rotary wheel button 13, and the like, for example. The button 11 disposed closer to the center of the upper portion of the casing 10 functions as a left button of a mouse as an input device for a PC, for example, and the button 12 adjacent to the button 11 functions as a right button of the mouse.

For example, a “drag and drop” operation may be executed by moving the input apparatus 1 while pressing the button 11, a file may be opened by double-clicking the button 11, and a screen 3 may be scrolled by the wheel button 13. Locations of the buttons 11 and 12 and the wheel button 13, a content of a command issued, and the like can arbitrarily be changed.

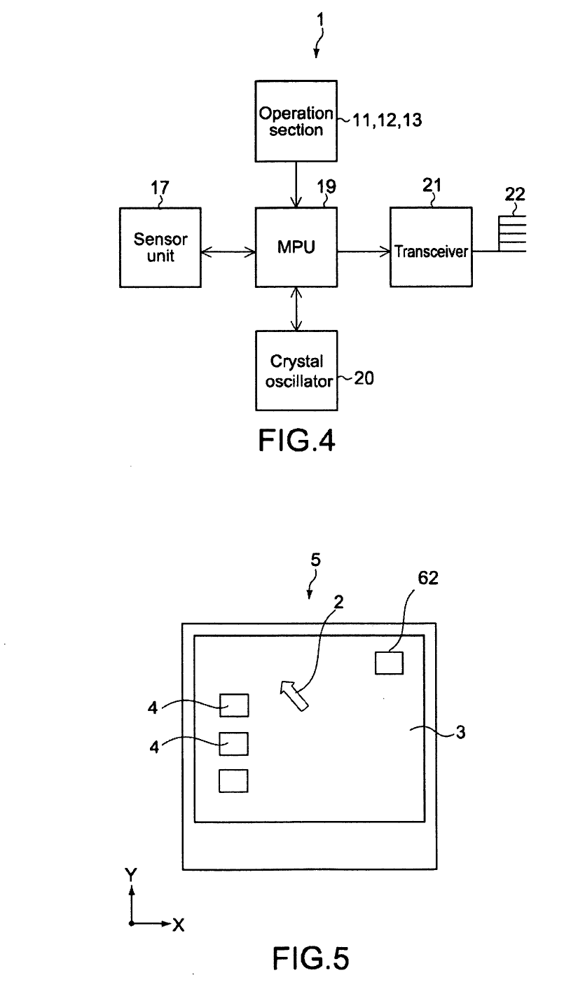

FIG. 3 is a diagram schematically showing an internal structure of the input apparatus 1. FIG. 4 is a block diagram showing an electrical structure of the input apparatus 1.

The input apparatus 1 includes a sensor module 17, a control unit 30 and batteries 14.

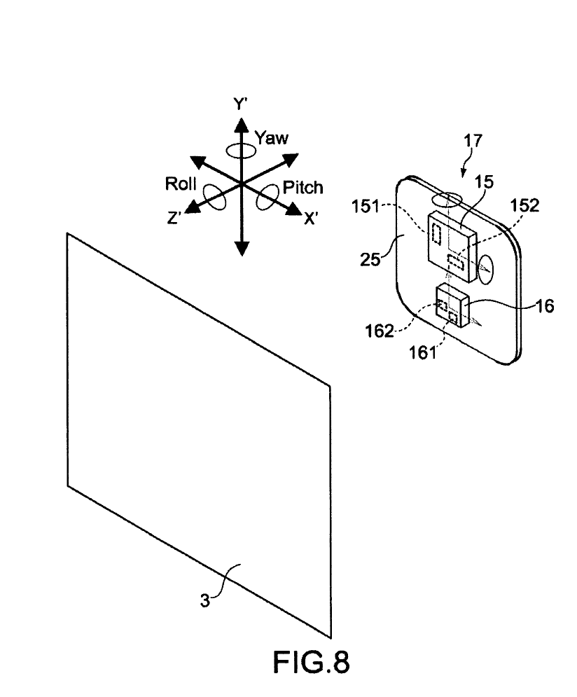

FIG. 8 is a perspective diagram showing the sensor module 17.

The sensor module 17 includes an acceleration sensor unit 16 for detecting accelerations in different angles such as along two orthogonal axes (X axis and Y axis). Specifically, the acceleration sensor unit 16 includes two sensors, that is, an acceleration sensor 161 (first or second acceleration sensor) for detecting an acceleration in an X-axis direction and an acceleration sensor 162 (second or first acceleration sensor) for detecting an acceleration in a Y-axis direction.

The sensor module 17 further includes an angular velocity sensor unit 15 for detecting angular velocities about the two orthogonal axes. Specifically, the angular velocity sensor unit 15 includes two sensors, that is, an angular velocity sensor 151 (first or second angular velocity sensor) for detecting an angular velocity in a rotational direction with the Y-axis direction as a center axis (yaw direction) and an angular velocity sensor 152 (second or first angular velocity sensor) for detecting an angular velocity in a rotational direction with the X-axis direction as a center axis (pitch direction). The acceleration sensor unit 16 and the angular velocity sensor unit 15 are packaged and mounted on a common surface of a circuit board 25 as a common substrate.

Because the plurality of sensor units 15 and 16 are thus mounted on the common circuit board 25, the sensor module 17 can be reduced in size, thickness, and weight as compared to a case where the sensor units are mounted on different circuit boards.

As each of the angular velocity sensors 151 and 152 for the yaw and pitch directions, respectively, a vibration gyro sensor for detecting Coriolis force in proportion to an angular velocity is used. As each of the acceleration sensors 161 and 162 for the X- and Y-axis directions, respectively, any sensor such as a piezoresistive sensor, a piezoelectric sensor, or a capacitance sensor may be used. Each of the angular velocity sensors 151 and 152 is not limited to the vibration gyro sensor, and a rotary top gyro sensor, a ring laser gyro sensor, a gas rate gyro sensor, and the like may also be used.

In descriptions on FIGS. 2 and 3, a longitudinal direction of the casing 10 is referred to as Z′ direction, a thickness direction of the casing 10 is referred to as X′ direction, and a width direction of the casing 10 is referred to as Y′ direction for convenience. In this case, the sensor module 17 is incorporated into the casing 10 such that a surface of the circuit board 25 on which the acceleration sensor unit 16 and the angular velocity sensor unit 15 are mounted becomes substantially parallel to an X′-Y′ plane. As described above, the sensor units 16 and 15 each detect physical amounts with respect to the two axes, that is, the X axis and the Y axis. In descriptions below, with regard to a movement of the input apparatus 1, a rotational direction about the X′ axis is sometimes referred to as pitch direction, a rotational direction about the Y′ axis is sometimes referred to as yaw direction, and a rotational direction about the Z′ axis (roll axis) is sometimes referred to as roll direction.

The control unit 30 includes a main substrate 18, an MPU 19 (Micro Processing Unit) (or CPU) mounted on the main substrate 18, a crystal oscillator 20, a transceiver 21, and an antenna 22 printed on the main substrate 18.

The MPU 19 includes a built-in volatile or nonvolatile memory (storage section) requisite therefore. The MPU 19 is input with a detection signal from the sensor module 17, an operation signal from the operation section, and the like, and executes various kinds of operational processing in order to generate predetermined control signals in response to those input signals. The memory may be provided separate from the MPU 19. It should be noted that the nonvolatile memory stores a program read out at a time of executing a calibration mode to be described later, parameters necessary for the various operations, correction values obtained by executing the calibration mode, and the like.

Typically, the sensor module 17 outputs analog signals. In this case, the MPU 19 includes an A/D (Analog/Digital) converter. Alternatively, the sensor module 17 may be a unit that includes the A/D converter.

The MPU 19 alone or the MPU 19 and the crystal oscillator 20 constitutes/constitute a velocity calculation unit.

The transceiver 21 (transmission means) transmits, as RF radio signals, the control signals (input information) generated in the MPU 19 to the control apparatus 40 via the antenna 22. At least one of the transceiver 21 and the antenna 22 constitutes a transmission unit.

The crystal oscillator 20 generates clocks and supplies them to the MPU 19. As the batteries 14, dry cell batteries, rechargeable batteries, and the like are used.

The control apparatus 40 is a computer and includes an MPU 35 (or CPU), a RAM 36, a ROM 37, a video RAM 41, an antenna 39, and a transceiver 38 as shown in FIG. 1.

The transceiver 38 (reception means) receives the control signal transmitted from the input apparatus 1 via the antenna 39. The MPU 35 (display control means) analyzes the control signal and executes various kinds of operational processing. Accordingly, a display control signal for controlling a UI displayed on a screen 3 of the display apparatus 5 is generated. The video RAM 41 stores screen data displayed on the display apparatus 5 generated in response to the display control signal.

The control apparatus 40 may be an apparatus dedicated to the input apparatus 1, or may be a PC or the like. The control apparatus 40 is not limited to the PC, and may be a computer integrally formed with the display apparatus 5, audiovisual equipment, a projector, a game device, a car navigation system, or the like.

Examples of the display apparatus 5 include a liquid crystal display and an EL (Electro-Luminescence) display, but are not limited thereto. The display apparatus 5 may alternatively be an apparatus integrally formed with a display and capable of receiving television broadcasts and the like.

FIG. 5 is a diagram showing an example of the screen 3 displayed on the display apparatus 5. UIs such as icons 4 and a pointer 2 are displayed on the screen 3. The icons are images on the screen 3 representing functions of programs, execution commands, file contents, and the like of the computer. It should be noted that on the screen 3, the horizontal direction is referred to as X-axis direction and the vertical direction is referred to as Y-axis direction. Unless stated otherwise, to help understand descriptions below, the UI as an operation target of the input apparatus 1 will be described as being the pointer 2 (so-called cursor).

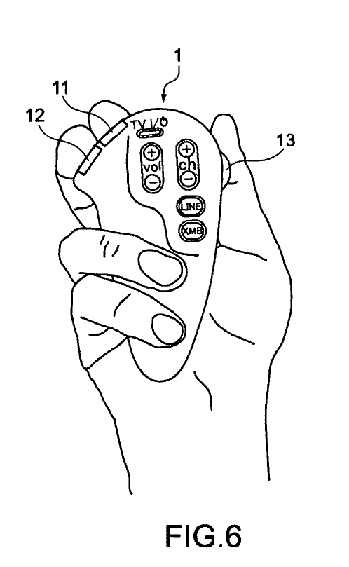

FIG. 6 is a diagram showing a state where a user is holding the input apparatus 1. As shown in FIG. 6, the input apparatus 1 may include, in addition to the buttons 11, 12, and 13, operation sections including various operation buttons such as those provided to a remote controller for operating a television or the like and a power switch, for example. When the user moves the input apparatus 1 in the air or operates the operation sections while holding the input apparatus 1 as shown in the figure, input information thereof is output to the control apparatus 40, and the control apparatus 40 controls the UI.

### (Basic Operation of Control System)

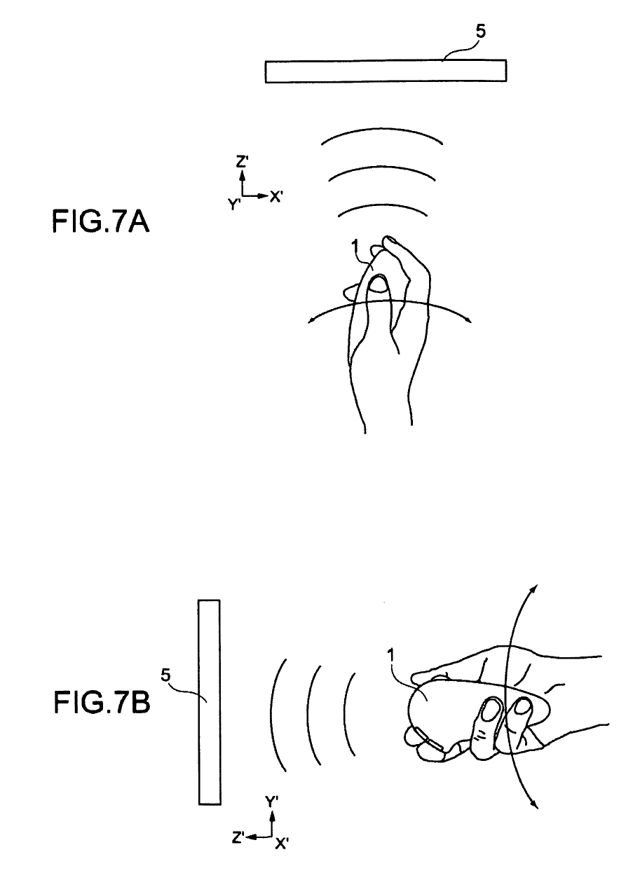

Next, a description will be given on typical examples of ways of moving the input apparatus 1 and ways the pointer 2 moves on the screen 3 accordingly. FIG. 7 are explanatory diagrams therefore.

As shown in FIGS. 7A and 7B, the user holds the input apparatus 1 so as to aim the buttons 11 and 12 side of the input apparatus 1 at the display apparatus 5 side. The user holds the input apparatus 1 so that a thumb is located on an upper side and a pinky is located on a lower side as in handshakes. In this state, the circuit board 25 of the sensor module 17 (see FIG. 8) is close to being in parallel with the screen 3 of the display apparatus 5, and the two axes as detection axes of the sensor module 17 respectively correspond to the horizontal axis (X axis) and the vertical axis (Y axis) on the screen 3. Hereinafter, the position of the input apparatus 1 as shown in FIGS. 7A and 7B will be referred to as reference position.

As shown in FIG. 7A, in the reference position, the user swings a wrist or an arm in the lateral direction, that is, the yaw direction. At this time, the acceleration sensor 161 for the X′-axis direction detects an acceleration aₓ in the X′-axis direction (first or second acceleration value), and the angular velocity sensor 151 for the yaw direction detects an angular velocity ω_{ψ} about the Y′ axis (first or second angular velocity value). Based on those detection values, the control apparatus 40 controls display of the pointer 2 so that the pointer 2 moves in the X-axis direction.

Meanwhile, as shown in FIG. 7B, in the reference position, the user swings the wrist or the arm in the vertical direction, that is, the pitch direction. At this time, the acceleration sensor 162 for the Y′-axis direction detects an acceleration a_{y} in the Y′-axis direction (second or first acceleration value), and the angular velocity sensor 152 for the pitch direction detects an angular velocity ω_{θ} about the X′ axis (second or first angular velocity value). Based on those detection values, the control apparatus 40 controls display of the pointer 2 so that the pointer 2 moves in the Y-axis direction.

In descriptions below, an absolute coordinate system is expressed using the X axis, Y axis, and Z axis, whereas a coordinate system that moves integrally with the input apparatus 1 (coordinate system of input apparatus 1) is expressed using the X′ axis, Y′ axis, and Z′ axis.

Although descriptions will be given later, in one embodiment, the MPU 19 of the input apparatus 1 calculates velocity values in the yaw and pitch directions based on the detection signals detected by the sensor module 17, in accordance with programs stored in the built-in nonvolatile memory. The input apparatus 1 transmits the velocity values to the control apparatus 40.

The control apparatus 40 converts a displacement in the yaw direction per unit time into a displacement amount of the pointer 2 on the X axis on the screen 3, and converts a displacement in the pitch direction per unit time into a displacement amount of the pointer 2 on the Y axis on the screen 3, and thus moves the pointer 2.

Typically, regarding the velocity values supplied every predetermined number of clocks, the MPU 35 of the control apparatus 40 adds an n-th velocity value that has been supplied to a (n-1)-th velocity value that has been supplied. Accordingly, the n-th velocity value that has been supplied corresponds to the displacement amount of the pointer 2, and coordinate information of the pointer 2 on the screen 3 is generated.

In another embodiment, the input apparatus 1 transmits physical amounts detected by the sensor module 17 to the control apparatus 40. In this case, the MPU 35 of the control apparatus 40 calculates the velocity values in the yaw and pitch directions based on the received input information in accordance with the program stored in the ROM 37, and controls display so that the pointer 2 moves in accordance with the velocity values.

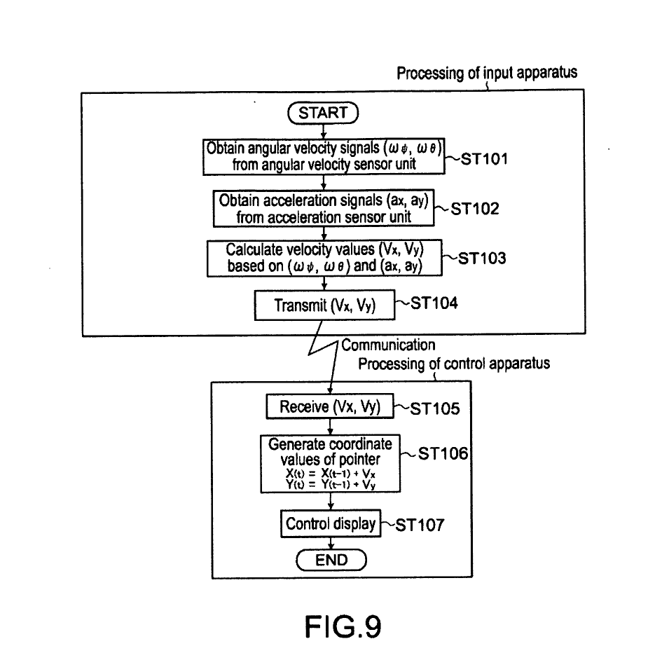

Next, an example of an operation of the input apparatus 1 and the control system 100 will be described. FIG. 9 is a flowchart showing a typical example of the operation. It should be noted that operational examples shown in FIGS. 9 to 12 are specific examples of an “operation mode” of the input apparatus 1.

The power of the input apparatus 1 is turned on. For example, the user turns on the power supply switch or the like provided to the input apparatus 1 or the control apparatus 40 to turn on the power of the input apparatus 1. Upon turning on the power, biaxial angular velocity signals are output from the angular velocity sensor unit 15. The MPU 19 obtains the first angular velocity value ω_{ψ} and the second angular velocity value ω_{θ} from the biaxial angular velocity signals (Step 101).

Further, upon turning on the power of the input apparatus 1, biaxial acceleration signals are output from the acceleration sensor unit 16. The MPU 19 obtains the first acceleration value aₓ and the second acceleration value a_{y} from the biaxial acceleration signals (Step 102). The signals of the acceleration values are signals corresponding to the position of the input apparatus 1 at a point when the power is turned on (hereinafter, referred to as initial position). Hereinafter, the initial position will be described as being the reference position. It should be noted that the MPU 19 typically carries out the processes of Steps 101 and 102 in sync with a predetermined clock cycle.

Based on the acceleration values (aₓ, a_{y}) and the angular velocity values (ω_{ψ}, ω_{θ}), the MPU 19 calculates velocity values (first and second velocity values Vₓ and V_{y}) by a predetermined operation (Step 103). The first velocity value Vₓ is a velocity value in a direction along the X axis, and the second velocity value V_{y} is a velocity value in a direction along the Y axis. A calculation method of the velocity values will be described later in detail. Considering this point, at least the sensor module 17 alone or the MPU 19 and the sensor module 17 functions/function as a movement signal output means for outputting velocity-related values as movement signals of the input apparatus 1. In this embodiment, the velocity values are taken as an example of the velocity-related values.

As described above, in this embodiment, instead of simply integrating the acceleration values (aₓ, a_{y}) to calculate the velocity values (Vₓ, V_{y}), the velocity values (Vₓ, V_{y}) are calculated based on the acceleration values (aₓ, a_{y}) and the angular velocity values (ω_{ψ}, ω_{θ}). Accordingly, usability of the input apparatus 1 that matches an intuition of the user can be obtained, and the movement of the pointer 2 on the screen 3 also matches the movement of the input apparatus 1 accurately. However, the velocity values (Vₓ, V_{y}) do not always need to be calculated based on the acceleration values (aₓ, a_{y}) and the angular velocity values (ω_{ψ}, ω_{θ}), and it is also possible for the velocity values (Vₓ, V_{y}) to be calculated by simply integrating the acceleration values (aₓ, a_{y}).

The MPU 19 transmits information on the calculated pointer velocity values (Vₓ, V_{y}) to the control apparatus 40 via the transceiver 21 and the antenna 22 (Step 104).

The MPU 35 of the control apparatus 40 receives the information on the pointer velocity values (Vₓ, V_{y}) via the antenna 39 and the transceiver 38 (Step 105). Because the input apparatus 1 transmits the pointer velocity values (Vₓ, V_{y}) every predetermined clocks, that is, per unit time, the control apparatus 40 can receive this and obtain displacement amounts in the X- and Y-axis directions per unit time.

The MPU 35 generates coordinate values (X(t), Y(t)) of the pointer 2 on the screen 3 that correspond to the obtained displacement amounts in the X- and Y-axis directions per unit time using Equations (1) and (2) below (Step 106). Based on the generated coordinate values, the MPU 35 controls display so that the pointer 2 moves on the screen 3 (Step 107) (display control means).

X(t)=X(t−1)+Vₓ′ (1)

Y(t)=Y(t−1)+V_{y}′ (2)

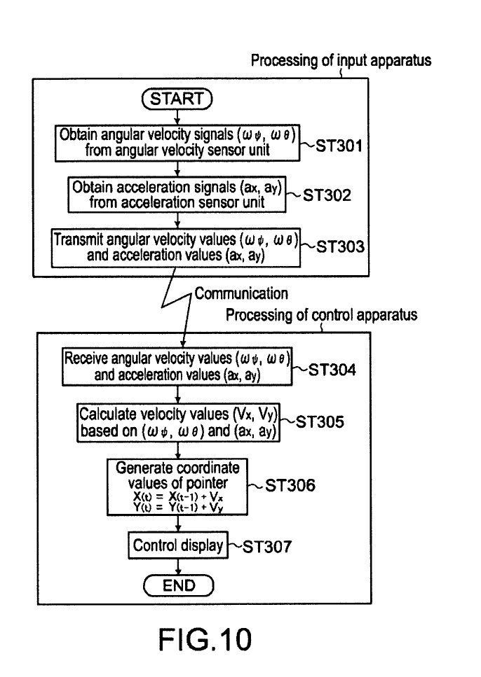

In FIG. 9, the input apparatus 1 carries out the main operations to calculate the pointer velocity values (Vₓ, V_{y}). However, in an embodiment shown in FIG. 10, the control apparatus 40 carries out the main operations.

As shown in FIG. 10, processes of Steps 301 and 302 are the same as those of Steps 101 and 102. The input apparatus 1 transmits information on detection values, that is, biaxial acceleration values and biaxial angular velocity values output from the sensor module 17, to the control apparatus 40, for example (Step 303). The MPU 35 of the control apparatus 40 receives the information on the detection values (Step 304) and executes the same processes as Steps 103, 106, and 107 (Steps 305 to 307).

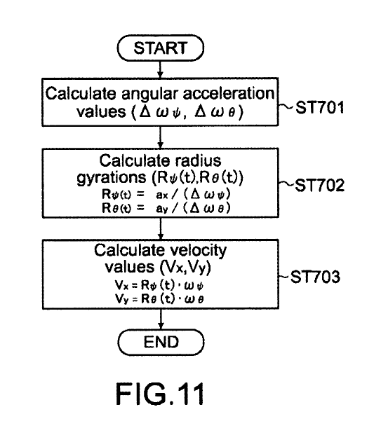

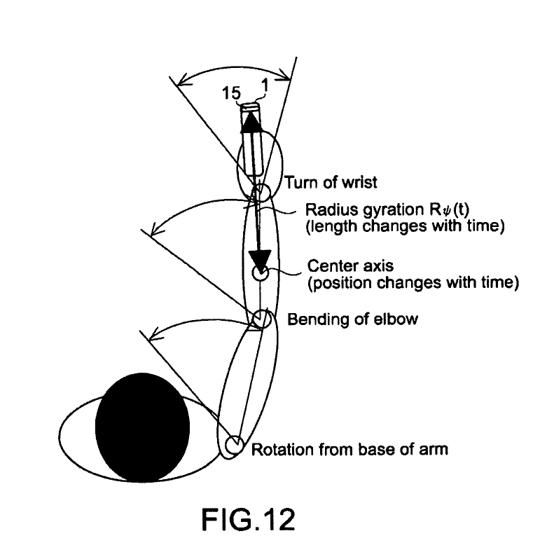

Hereinafter, a description will be given on a method of calculating the velocity values (Vₓ, V_{y}) in Step 103 of FIG. 9 and Step 305 of FIG. 10. FIG. 11 is a flowchart showing an operation of the input apparatus 1. FIG. 12 is a diagram for illustrating a basic idea of the velocity value calculation method.

FIG. 12 is a top view of the user operating the input apparatus 1 by swinging it in, for example, the lateral direction (yaw direction). As shown in FIG. 12, when the user operates the input apparatus 1 naturally, an operation is made by using at least one of a turn of a wrist, a bending of an elbow, and a rotation from a base of an arm. Therefore, a comparison between the movement of the input apparatus 1 and the rotations of a wrist, elbow, and base of an arm shows that there exist relationships of 1 and 2 below.

1. The angular velocity value ω_{ψ} about the Y axis of a portion of the input apparatus 1 at which the acceleration sensor unit 16 is disposed (hereinafter, tip end portion) is a combined value of an angular velocity obtained by the turn of a wrist, an angular velocity obtained by the bending of an elbow, and an angular velocity obtained by the rotation from a base of an arm.

2. The velocity value Vₓ in the yaw direction at the tip end portion of the input apparatus 1 is a combined value of values obtained by respectively multiplying the angular velocities of the wrist, elbow, and base of an arm by a distance between the wrist and the tip end portion, a distance between the elbow and the tip end portion, and a distance between the base of an arm and the tip end portion.

Here, regarding a rotational movement of the input apparatus 1 in a minute time, the input apparatus 1 can be considered to be rotating about a center axis (first center axis or second center axis) parallel to the Y axis and whose position changes with time. Assuming that a distance between the center axis whose position changes with time and the tip end portion of the input apparatus 1 is a radius gyration R_{ψ}(t) about the Y axis (first radius gyration or second radius gyration), the relationship between the velocity value Vₓ and the angular velocity value ω_{ψ} at the tip end portion of the input apparatus 1 can be expressed by Equation (3) below. In other words, the velocity value Vₓ in the yaw direction becomes a value obtained by multiplying the angular velocity value ω_{ψ} about the Y axis by the distance R_{ψ}(t) between the center axis and the tip end portion.

Vₓ=R_{ψ}(t)*ω_{ψ} (3)

It should be noted that in this embodiment, the acceleration sensor unit 16 and the angular velocity sensor unit 15 are provided integrally on the circuit board 25 of the sensor module 17. Therefore, the radius gyration R_{ψ}(t) becomes a distance from the center axis to the sensor module 17. However, when the acceleration sensor unit 16 and the angular velocity sensor unit 15 are provided apart from each other inside the casing 10, the distance from the center axis to the acceleration sensor unit 16 becomes the radius gyration R_{ψ}(t) as described above.

As shown in Equation (3), the relationship between the velocity value and the angular velocity value at the tip end portion of the input apparatus 1 is a proportional relationship, that is, a correlation with R_{ψ}(t) as a proportional constant.

Equation (3) above is modified to obtain Equation (4).

R_{ψ}(t)=Vₓ/ω_{ψ} (4)

The right-hand side of Equation (4) is a velocity dimension. Even when the velocity value and the angular velocity value represented on the right-hand side of Equation (4) are differentiated to obtain a dimension of the acceleration or acceleration time change rate, the correlation is not lost. Similarly, even when the velocity value and the angular velocity value are integrated to obtain a displacement dimension, the correlation is not lost.

Therefore, with the velocity and the angular velocity represented on the right-hand side of Equation (4) as a dimension of the displacement, acceleration, and acceleration time change rate, Equations (5), (6), and (7) below can be obtained.

R_{ψ}(t)=x/ψ (5)

R_{ψ}(t)=aₓ/Δω_{ψ} (6)

R_{ψ}(t)=Δaₓ/Δ(Δω_{ψ}) (7)

Focusing on Equation (6) out of Equations (4), (5), (6), and (7) above, for example, it can be seen that the radius gyration R_{ψ}(t) can be obtained if the acceleration value aₓ and the angular acceleration value Δω_{ψ} are known. As described above, the acceleration sensor 161 detects the acceleration value aₓ in the X-axis direction, and the angular velocity sensor 151 detects the angular velocity value ω_{ψ} about the Y axis. Therefore, if the angular velocity value ω_{ψ} about the Y axis is differentiated to thus calculate the angular acceleration value Δω_{ψ} about the Y axis, the radius gyration R_{ψ}(t) about the Y axis can be obtained.

If the radius gyration R_{ψ}(t) about the Y axis is known, the velocity value Vₓ of the input apparatus 1 in the X-axis direction can be obtained by multiplying the radius gyration R_{ψ}(t) by the angular velocity value ω_{ψ} about the Y axis detected by the angular velocity sensor 151 (see Equation (3)). Specifically, a rotational operation amount itself of the user is converted into a linear velocity value in the X-axis direction, with the result that a velocity value that matches an intuition of the user is obtained. Therefore, because the movement of the pointer 2 becomes a natural movement with respect to the movement of the input apparatus 1, operability of the input apparatus for the user is improved.

This velocity value calculation method can also be applied in a case where the user operates the input apparatus 1 by swinging it in the vertical direction (pitch direction).

FIG. 1 shows an example where Equation (6) is used. Referring to FIG. 11, by performing the differential operation on the angular velocity values (ω_{ψ}, ω_{θ}) obtained in Step 101, the MPU 19 of the input apparatus 1 calculates angular acceleration values (Δω_{ψ}, Δω_{θ}) (Step 701).

Using the acceleration values (aₓ, a_{y}) obtained in Step 102 and the angular acceleration values (Δω_{ψ}, Δω_{θ}), the MPU 19 calculates the radius gyrations (R_{ψ}(t), R_{θ}(t)) about the Y axis and the X axis using Equations (6) and (8) (Step 702).

R_{ψ}(t)=aₓ/Δω_{ψ} (6)

R_{θ}(t)=a_{y}/Δω_{θ} (8)

After the radius gyrations are calculated, the velocity values (Vₓ, V_{y}) are calculated using Equations (3) and (9) (Step 703).

Vₓ=R_{ψ}(t)*ω_{ψ} (3)

V_{y}=R_{θ}(t)*ω_{θ} (9)

The rotational operation amounts themselves of the user with respect to the input apparatus 1 are thus converted into the linear velocity values in the X- and Y-axis directions, with the result that the velocity values that match the intuition of the user are obtained.

Further, by using the acceleration values (aₓ, a_{y}) detected by the acceleration sensor unit 16 as they are, the calculation amount can be reduced, and power consumption of the input apparatus 1 can be reduced.

The MPU 19 only needs to obtain (aₓ, a_{y}) from the acceleration sensor unit 16 every predetermined clocks, and calculate the velocity values (Vₓ, V_{y}) in sync therewith, for example. Alternatively, the MPU 19 may calculate the velocity values (Vₓ, V_{y}) once every time a plurality of acceleration values (aₓ, a_{y}) are sampled.

### (Detection of Sensor Output)

The input apparatus 1 of this embodiment uses the sensor module 17 including the angular velocity sensors (angular velocity sensor unit 15) and the acceleration sensors (acceleration sensor unit 16) that do not detect displacements directly, but detect inertial amounts in a dimension of the displacements obtained by temporally differentiating, the angular velocities, accelerations, and the like. Those inertial sensors each detect a fluctuation of a potential with respect to a reference potential, that corresponds to the movement of the input apparatus 1, as a detection signal.

Hereinafter, an exemplary method of detecting angular velocities will be described while taking the angular velocity sensor as an example.

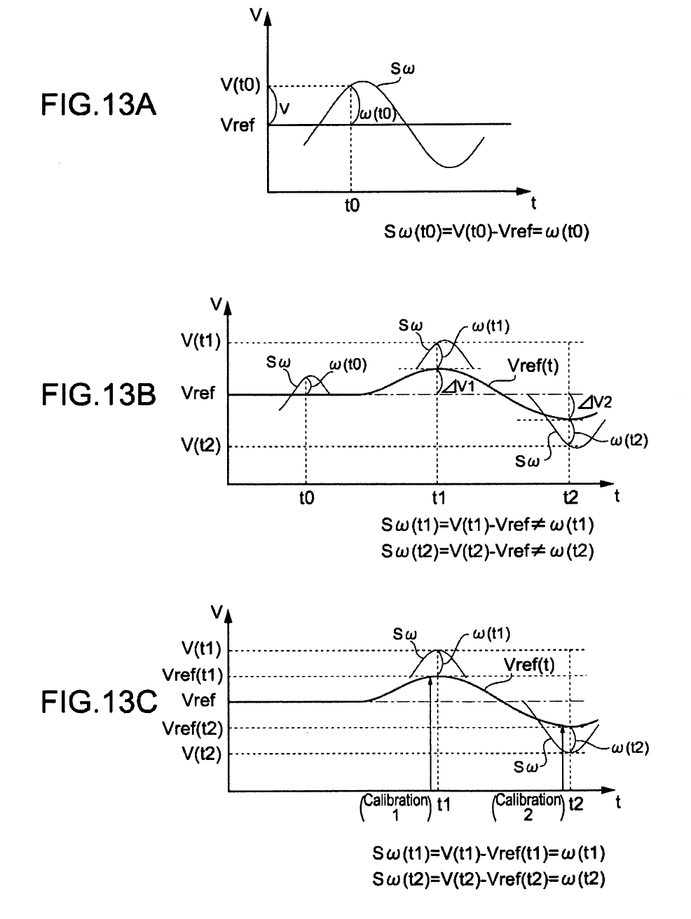

FIG. 13A shows an example of an output of the angular velocity sensor. The angular velocity sensor outputs a potential signal Sω with a reference potential Vref as a reference. An angular velocity value ω(t0) at a time t0 can be obtained by an operation shown in Equation (10), with reference to the angular velocity signal Sω(t0).

Sω(t0)=V(t0)−Vref (10)

The reference potential Vref may be a ground potential or a DC (direct current) potential offset with respect to the ground potential. The reference potential Vref is sometimes referred to as a DC offset (value), a DC center (value), or the like. In either case, the output signal Sω of the angular velocity sensor includes the reference potential Vref and a potential signal with respect to the reference potential Vref, that corresponds to the movement of the input apparatus (casing). The slower the movement of the casing is, the smaller the fluctuation of the potential (V) from the reference potential Vref becomes, whereas the larger the movement of the casing is, the larger the fluctuation of the potential (V) from the reference potential Vref becomes. Therefore, unless the reference potential Vref is known, it is almost impossible to accurately detect the movement of the casing.

### (Calibration of Sensor)

The reference potential Vref of the sensor is set as appropriate based on sensitivity characteristics of the sensor unit, electrical characteristics of peripheral circuits or devices, and the like. However, the reference potential Vref fluctuates according to characteristics (e.g., temperature drift and change in vibration mode) of devices constituting the sensor, an external stress, and circuit characteristics (e.g., temperature characteristics, time constant, and SN ratio of amplifier output) of analog circuits, and a transition of the fluctuation is not uniform. FIG. 13B shows an example of the fluctuation of the reference potential Vref.

The fluctuation of the reference potential Vref causes a deviation in the calculation of the angular velocity values. This is because, when the reference potential Vref is a fixed value, the angular velocity value ω is calculated based on Equation (10) with the set reference value Vref as a reference, regardless of the fluctuation of the reference potential.

For example, in the example of FIG. 13B, an angular velocity value ω(t1) at a time t1 is calculated using Equation (11) based on an angular velocity signal Sω(t1), and an angular velocity value ω(t2) at a time t2 is calculated using Equation (12) based on an angular velocity signal Sω(t2).

Sω(t1)=V(t1)−Vref (11)

Sω(t2)=V(t2)−Vref (12)

However, the reference potential Vref fluctuates with time, thus resulting in a value different from a preset value. In the example of FIG. 13B, the actual angular velocity value ω(t1) at the time t1 is deviated only by ΔV1 by the value calculated in Equation (11), and the actual angular velocity value ω(t2) at the time t2 is deviated only by ΔV2 by the value calculated in Equation (12). In this case, the operational feeling of the input apparatus is of course deteriorated, but a situation in which the pointer moves on the screen even when the input apparatus is stopped is also induced.

In this regard, for enhancing the operational feeling of the input apparatus, it is necessary to periodically or unperiodically carry out processing of canceling the fluctuation of the reference potential Vref. This processing is generally called calibration or zero-point calibration, for example. As shown in FIG. 13C, by successively carrying out the calibration (correction of reference potential) of the sensor, it becomes possible to enhance detection accuracy of the angular velocity values ω(t1) and ω(t2) at the times t1 and t2, respectively, as shown in Equations (13) and (14).

Sω(t1)=V(t1)−Vref(t1) (13)

Sω(t2)=V(t2)−Vref(t2) (14)

As described above, the sensor calibration is processing corresponding to a modification or reset of the reference potential value. Therefore, higher calibration accuracy can be obtained as the movement of the casing is less reflected on the output signals of the sensors, that is, as the state of the input apparatus becomes closer to the static state. As the method of calibrating the sensor in the input apparatus of this type, there is known a method of correcting a reference potential of a sensor by assuming that an input apparatus is in a static state when an output of a gyro sensor is equal to or smaller than a predetermined threshold value (see U.S. Pat. No. 5,825,350).

By this method, however, a calibration is started as long as a certain condition is satisfied during an operation of the input apparatus. Therefore, there are cases where, while a user is moving the input apparatus slowly in one direction at approximately a constant velocity, the calibration processing is executed with an output value of the gyro sensor at this time as a reference. In this case, a cursor moves on its own in a direction opposite to the one direction even when the movement of the input apparatus is stopped, which is inconvenient and causes deterioration of the operational feeling.

Meanwhile, it is possible to solve the above problem by strictly (narrowly) setting a threshold value for the sensor output that is to be a reference for starting the calibration. However, if the threshold value is set strictly, there is a fear that, due to noises and minute vibrations in the environment, an inconvenience that a mode cannot be shifted to a calibration mode even though the input apparatus is not actually operated or is in the static state may be newly caused.

### (Calibration Function of Input Apparatus)

As described above, the input apparatus 1 of this embodiment includes the casing 10, the sensor module 17 as the sensor, and the MPU 19 as the velocity calculation unit. The sensor module 17 includes the annular velocity sensor unit 15 and the acceleration sensor unit 16 that each output, as a detection signal, the fluctuation of the potential with respect to the reference potential, that corresponds to the movement of the casing 10. As described above, the MPU 19 has a function of calculating the pointer velocity values (Vₓ, V_{y}) that are velocity values for moving the pointer 2 based on the detection signals of the sensor module 17, and executing an operation mode as processing for moving the pointer 2 on the screen 3 in accordance with the pointer velocity values (second execution means).

In addition, the MPU 19 has a function of executing a calibration mode as processing for correcting the reference potential of the sensor (first execution means). The input apparatus 1 of this embodiment includes a switch for switching the execution of the calibration mode to the execution of the operation mode and vise versa based on an input operation from outside.

The switch is structured to be capable of switching the modes in accordance with the input operation from the outside, for detecting whether the input apparatus is being used by the user or not. In this embodiment, the switch is constituted of a sensor that detects whether the user is holding the input apparatus 1.

In the input apparatus 1 shown in FIG. 2, a lower-half area of the casing 10 is constituted as a grip portion G that is held by the user. A proximity sensor 51 that functions as the switch is provided at a part of the area of the grip portion G. In this embodiment, the proximity sensor 51 is constituted of a capacitance sensor. An output of the proximity sensor 51 is supplied to the MPU 19.

When the output of the proximity sensor 51 corresponds to an output thereof obtained when the user is holding the grip portion G, the MPU 19 recognizes that the user is using the input apparatus 1 and executes the operation mode. On the other hand, when the output of the proximity sensor 51 corresponds to an output thereof obtained when the user is not holding the grip portion G, the MPU 19 recognizes that the user is not using the input apparatus 1 and switches the execution of the operation mode to the execution of the calibration mode. Details of the calibration mode will be given later.

Thus, in this embodiment, the proximity sensor 51 that switches the execution of the calibration mode to the execution of the operation mode and vise versa in accordance with the input operation from the outside (by detecting an operated or unoperated state of the input apparatus 1 by the user) is provided. According to this embodiment, the calibration processing of the sensor module 17 can be prevented from being executed when the user is holding the input apparatus 1 in hand and operating it. In other words, according to this embodiment, the user's intention of using the input apparatus can be reflected on the detection of the static state of the input apparatus 1, thus making it possible to appropriately correct the sensor module 17.

Further, according to this embodiment, because the input apparatus 1 can be judged as being in the unused state, that is, the static state when the user is not holding the grip portion G of the casing 10, the calibration processing of the sensor module 17 can be carried out appropriately.

A position and (a range of) a detection area of the proximity sensor 51 are not limited as long as the proximity sensor 51 is capable of detecting, at the grip portion G of the casing 10, a state where the user is holding the input apparatus in hand. Further, also considering that the user operates the input apparatus 1 by holding the casing 10 with either the right hand or the left hand, it is also possible to provide the proximity sensor on both the left- and right-hand surfaces of the grip portion G of the casing 10, or provide the proximity sensor in an area where fingers of both the left and right hands touch.

Moreover, instead of the capacitance sensor, it is also possible for the proximity sensor 51 to be constituted of, for example, an optical sensor that uses a photo interrupter. Alternatively, instead of the proximity sensor, a pressure sensor that detects an in-contact state or a grip pressure by the method above may be used.

On the other hand, the control system 100 of this embodiment includes a notification means for making the user recognize which of the operation mode and the calibration mode is being executed in the input apparatus 1. The notification means can be constituted of, for example, a mode display lamp 61 provided at the upper portion of the casing 10 of the input apparatus 1 as shown in FIG. 2, or a luminescent display means such as a mode display section 62 displayed on the screen 3 of the display apparatus 5 as shown in FIG. 5.

The mode display lamp 61 can be constituted of a monochrome or multicolor LED lamp capable of emitting colored light that can be visually recognized by the user. When the calibration mode is being executed, the MPU 19 causes the mode display lamp 61 to emit light in a first luminescence pattern, and when the operation mode is being executed, causes the mode display lamp 61 to emit light in a second luminescence pattern different from the first luminescence pattern.

The luminescence pattern of the mode display lamp 61 includes a luminescent color, a flash mode, and a flash cycle. For example, when the calibration mode is being executed, red light blinks at a relatively-fast flash cycle, and when the operation mode is being executed, the mode display lamp 61 is constantly lit in green light. It should be noted that when the calibration mode is constituted of a plurality of modes, luminescence patterns corresponding to respective modes can additionally be set as the first luminescence pattern.

By differentiating the luminescence pattern of the mode display lamp 61 between the calibration mode and the operation mode, it becomes possible for the user to easily recognize which mode is being executed in the input apparatus 1. Moreover, by notifying the user that the calibration mode is being executed, an effect of preventing the user from making an unintentional operation to the input apparatus can be expected, and an appropriate environment for the calibration can thus be maintained.

The mode display section 62 is displayed on the screen 3 together with the icons 4 or the pointer 2 in a form that the user can visually recognize. A display position of the mode display section 62 is not particularly limited and may be displayed at a corner portion of the screen 3, for example. It is of course possible to constitute the mode display section 62 by an icon.

The mode display section 62 is displayed in display patterns that are different for the calibration mode and the operation mode. When the calibration mode is being executed, the MPU 35 (display control means) of the control apparatus 40 displays the mode display section 62 in a first display pattern, and when the operation mode is being executed, displays the mode display section 62 in a second display pattern different from the first display pattern. In this case, the input apparatus 1 transmits an identification signal indicating a mode type to the control apparatus 40 together with the pointer velocity values. Based on the received identification signal, the MPU 35 controls display of the mode display section 62.

A display content of the mode display section 62 may be character information like “in calibration mode” or “in operation mode”, or information containing an arbitrary symbol or mark with which the user can distinguish the mode, or a combination of those with characters. Further, the mode display section 62 may be displayed in a color different for each mode, or may be displayed while blinking differently for each mode.

By differentiating the display pattern of the mode display section 62 between the calibration mode and the operation mode, it becomes possible for the user to visually recognize which mode is being executed in the input apparatus 1. Moreover, by notifying the user that the calibration mode is being executed, an effect of preventing the user from making an unintentional operation to the input apparatus can be expected, and an appropriate environment for the calibration can thus be maintained.

Instead of being displayed on the screen 3 of the display apparatus 5, the mode display section 62 may be provided to a casing of the control apparatus 40 or displayed on a display section of the control apparatus 40.

The notification means is not limited to the luminescent display means such as the mode display lamp 61 and the mode display section 62 described above. For example, the notification means can be constituted of a sound generation means such as a speaker. In addition, it is also possible to constitute the notification means by a combination of the luminescent display means and the sound generation means. The sound generation means may be incorporated in the input apparatus 1 or the control apparatus 40, or may be constituted of a speaker of the display apparatus 5.

When the sound generation means is incorporated in the input apparatus 1, the MPU 19 causes the sound generation means to generate sound in a first sound pattern when the calibration mode is being executed, and causes the sound generation means to generate sound in a second sound pattern different from the first sound pattern when the operation mode is being executed.

Further, when the sound generation means is incorporated in the control apparatus 40, the MPU 35 causes the sound generation means to generate sound in the first sound pattern when the calibration mode is being executed, and causes the sound generation means to generate sound in the second sound pattern different from the first sound pattern when the operation mode is being executed.

Furthermore, when the sound generation means is constituted of the speaker of the display apparatus 5, the MPU 35 causes the sound generation means to generate sound in the first sound pattern when the calibration mode is being executed, and causes the sound generation means to generate sound in the second sound pattern different from the first sound pattern when the operation mode is being executed. In this case, the MPU 35 generates not only a display control signal but also a predetermined sound signal corresponding to the mode type, and outputs the signal to the display apparatus 5. Examples of the sound signal include an audio signal and a musical sound signal.

By generating sound in the sound patterns different for the calibration mode and the operation mode, it becomes possible for the user to auditorily recognize which mode is being executed in the input apparatus 1. Moreover, by notifying the user that the calibration mode is being executed, an effect of preventing the user from making an unintentional operation to the input apparatus can be expected, and an appropriate environment for the calibration can thus be maintained.

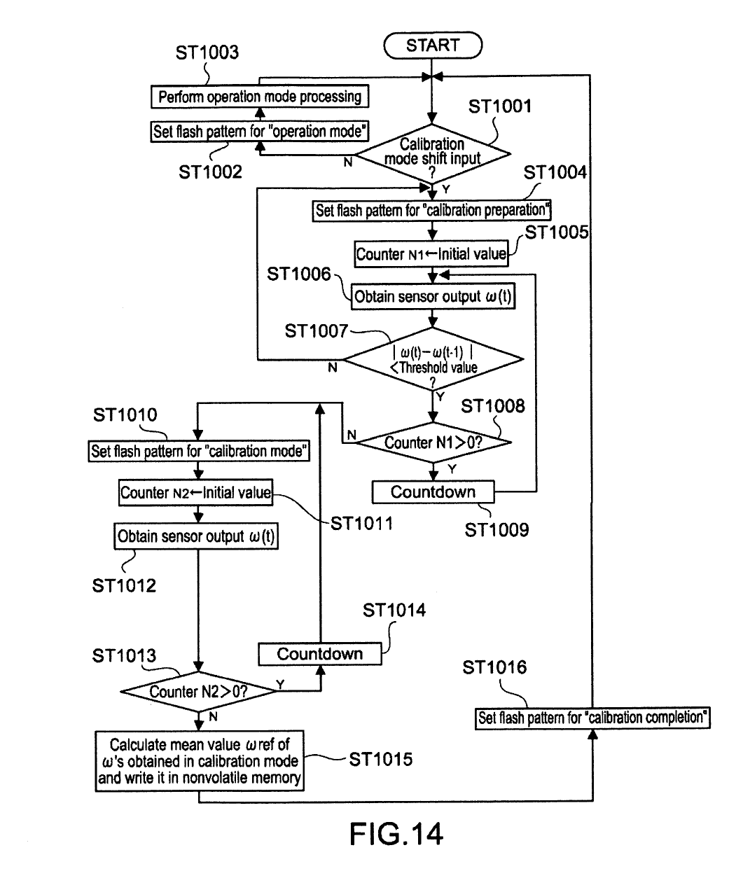

### (Calibration Flow of FIG. 14)

Next, an embodiment of the calibration mode will be described. FIG. 14 is a calibration flow of the sensor module 17 carried out by the MPU 19. The example in the figure shows the calibration processing of the angular velocity sensor unit 15, but the same applies to the calibration processing of the acceleration sensor unit 16.

Here, a state where the user is operating the input apparatus 1 will first be described. In Step 1001, it is judged whether an operational mode of the input apparatus 1 is the calibration mode. This judgment is made based on the output of the proximity sensor 51. In this case, because the output of the proximity sensor 51 corresponds to the output thereof obtained when the user is holding the casing 10, the operational mode of the input apparatus 1 is judged as being the operation mode.

When it is judged that the input apparatus 1 is in the operation mode based on the output of the proximity sensor 51, the mode display lamp 61 is caused to emit light in the second luminescence pattern, and processing of the operation mode is executed (continued) (Steps 1002 and 1003). The operation mode of the input apparatus 1 corresponds to the operational example described with reference to FIGS. 9 to 12. The processes of Steps 1001 to 1003 are continued until the operational mode of the input apparatus 1 shifts to the calibration mode.

Assuming that the user has stopped operating the input apparatus 1 and has placed the input apparatus 1 on a static support pedestal (support means) such as a table, a battery charger, or a dedicated stand, since the input apparatus 1 is released from the hand of the user, an output corresponding to the output obtained when the user is not holding the casing 10 is normally transmitted from the proximity sensor 51. Based on the output of the proximity sensor 51, the MPU 19 switches the operational mode of the input apparatus 1 from the operation mode to the calibration mode (Step 1001).

In this embodiment, the calibration mode is constituted of a calibration preparation mode and a subsequent calibration processing mode. The calibration preparation mode is for judging the static state of the casing 10. Normally, when the input apparatus 1 is released from the hand of the user, for the time being, the output of the sensor module 17 is unstable due to an effect of inertia and the like. Therefore, if the calibration is started during this period, high calibration accuracy cannot be obtained. In this regard, in this embodiment, instead of starting the calibration processing immediately after the shift to the calibration mode, a calibration preparation period for stabilizing the output of the sensor module 17 is provided so that the calibration can be carried out appropriately.

Referring to FIG. 14, an example of the calibration preparation mode will be described.

First, after the input apparatus 1 has shifted to the calibration mode, the mode display lamp 61 is caused to emit light in the first luminescence pattern (Step 1004). Here, as the first luminescence pattern, three patterns of a luminescence pattern for the calibration preparation mode, a luminescence pattern for the calibration processing, and a luminescence pattern for calibration completion are prepared additionally. In Step 1004, the mode display lamp 61 is caused to emit light in the luminescence pattern for the calibration preparation mode.

Next, a predetermined initial counter value N1 that defines a set period of the calibration preparation mode is set (Step 1005). A magnitude of the counter value N1 is arbitrary, and the value may be set as appropriate. The larger the counter value N1 becomes, the longer the calibration preparation period becomes.

Subsequently, the angular velocity values (ω_{ψ}, ω_{θ}) as detection signals of the angular velocity sensor unit 15 are obtained (Step 1006). Here, the angular velocity values ω_{ψ} and ω_{θ} of the angular velocity sensor unit 15 will collectively be represented by ω. It should be noted that ω_{ψ} and ω_{θ} may be corrected either individually or collectively. The obtained angular velocity values are stored in the memory of the MPU 19.

Next, it is judged whether a difference (absolute value) between the currently-obtained angular velocity value ω(t) and the previously-obtained angular velocity value ω(t−1), that is, an angular velocity time change rate (angular acceleration) is smaller than a predetermined threshold value Vth1 (Step 1007). Since it can be assumed that the input apparatus 1 is in the static state or a near-static state during the calibration preparation period, the difference between ω(t) and ω(t−1) is smaller than that in the operation mode. Therefore, a relatively-small value can be set for the threshold value Vth1.

When the difference between the angular velocity values is equal to or larger than the threshold value Vth1, it is judged that the input apparatus 1 is not in the static state or the near-static state, and the process returns to Step 1004. When the difference between the angular velocity values is smaller than the threshold value Vth1, the process advances to Step 1008 and a judgment is made on whether the counter value N1 has reached 0. When the counter value N1 has not yet reached 0, N1 is decremented a predetermined amount (Step 1009) and the process returns to Step 1006. After that, the same processes as those above are executed again (Steps 1006 to 1008).

The calibration preparation mode is executed as described above. The calibration preparation mode is continued until the counter value N1 reaches 0. At a point when the counter value N1 has reached 0, the calibration processing mode is started (Steps 1010 to 1016).

Hereinafter, the calibration processing mode will be described.

After the shift to the calibration processing mode, the mode display lamp 61 is caused to emit light in the luminescence pattern for the calibration processing mode out of the first luminescence pattern (Step 1010). The luminescence pattern for the calibration processing mode is different from the luminescence pattern for the calibration preparation mode described above (in color, flash cycle, and the like).

Next, a predetermined initial counter value N2 that defines a set period of the calibration processing mode is set (Step 1011). A magnitude of the counter value N2 is arbitrary, and the value may be set as appropriate. The larger the counter value N2 is, the larger the sample count of reference angular velocity values used for the calibration becomes, resulting in an enhancement of calibration accuracy. However, processing period for the calibration is elongated.

Subsequently, the angular velocity data ω(ω_{ψ}, ω_{θ}) output from the angular velocity sensor unit 15 is obtained (Step 1012). The obtained angular velocity values are stored in the memory (storage section) of the MPU 19. While the calibration processing mode is being executed, the static state of the input apparatus 1 is almost completely guaranteed since the calibration preparation mode has already been executed. Therefore, the angular velocities output from the angular velocity sensor unit 15 at this time become 0, that is, values almost equal to the reference potential.

After the obtained angular velocity data is stored in the memory, the process advances to Step 1013 and a judgment is made on whether the counter value N2 has reached 0. When the counter value N2 is not 0, the counter value N2 is decremented a predetermined amount (Step 1014) and the process returns to Step 1010. After that, the same processes as those above are executed again (Steps 1011 to 1013).

The angular velocity data is repeatedly obtained until the counter value N2 reaches 0. When the counter value N2 has reached 0, the MPU 19 calculates a mean value (ωref) of the obtained pieces of angular velocity data, and stores the value in the memory (Step 1015). The stored mean value (ωref) of the angular velocity data is applied as a correction value (first correction value) of the reference potential Vref.

The calibration processing mode is executed as described above. After the correction value is stored in the memory, the mode display lamp 61 of the input apparatus 1 is caused to emit light in the luminescence pattern for the calibration completion out of the first luminescence pattern (Step 1016), and the process returns to Step 1001. After that, the processes above are executed again.

In this embodiment, because the nonvolatile memory for storing the correction value obtained by executing the calibration mode is provided, the previously-corrected reference value of the sensor module 17 can be used as the reference value of the sensor module 17 at the time the power of the input apparatus 1 is turned on again. Accordingly, the angular velocity detection by the sensor module 17 can be carried out using the latest reference value at all times.

Here, in writing the correction value in the memory in Step 1015, it is also possible that, only when a difference between a correction value obtained by newly executing the calibration mode (second correction value) and the correction value stored in the memory (first correction value), that is previously obtained by executing the calibration mode, is equal to or smaller than a certain threshold value (first threshold value), the current correction value (second correction value) is stored in the memory by replacing the previous correction value (first correction value) therewith. Accordingly, it becomes possible to prevent the sensor module from being calibrated erroneously in a case where the current correction value is an anomalous value.

In addition, it is also possible that, only when the correction value obtained by newly executing the calibration mode (second correction value) is equal to or smaller than a certain threshold value (second threshold value), the current correction value (second correction value) is stored in the memory by replacing the previous correction value (first correction value) therewith. Accordingly, an appropriate calibration of the sensor module can be ensured.

On the other hand, when the current correction value (second correction value) exceeds the second threshold value, the calibration mode is executed again. In this case, it is also possible that, when a difference between a correction value obtained by re-executing the calibration mode (third correction value) and the current correction value (second correction value) is equal to or smaller than a certain threshold value (third threshold value), the second correction value is stored in the memory by replacing the first correction value therewith. In this case, the correction value to be stored in the memory is not limited to the second correction value, and the third correction value or a mean value of the second and third correction values may be stored instead, for example. Accordingly, an appropriate calibration of the sensor module can be realized.

In addition, it is also possible to cancel the execution of the calibration mode when the magnitude of the detection signal of the angular velocity sensor has exceeded a certain threshold value (fourth threshold value) that is large enough for the input apparatus 1 to be judged as having been operated, while the calibration mode is being executed. Accordingly, because the sensor module 17 can be prevented from being calibrated in a state where noises including disturbances and the like are incorporated in the input apparatus 1, the calibration can be made appropriate. Moreover, it is also possible to cancel the execution of the calibration mode when the proximity sensor 51 has switched the operational mode to the operation mode while the calibration mode is being executed. Accordingly, the sensor module 17 can be prevented from being calibrated regardless of the fact that the input apparatus 1 is executing the operation mode, with the result that the calibration can be made appropriate.

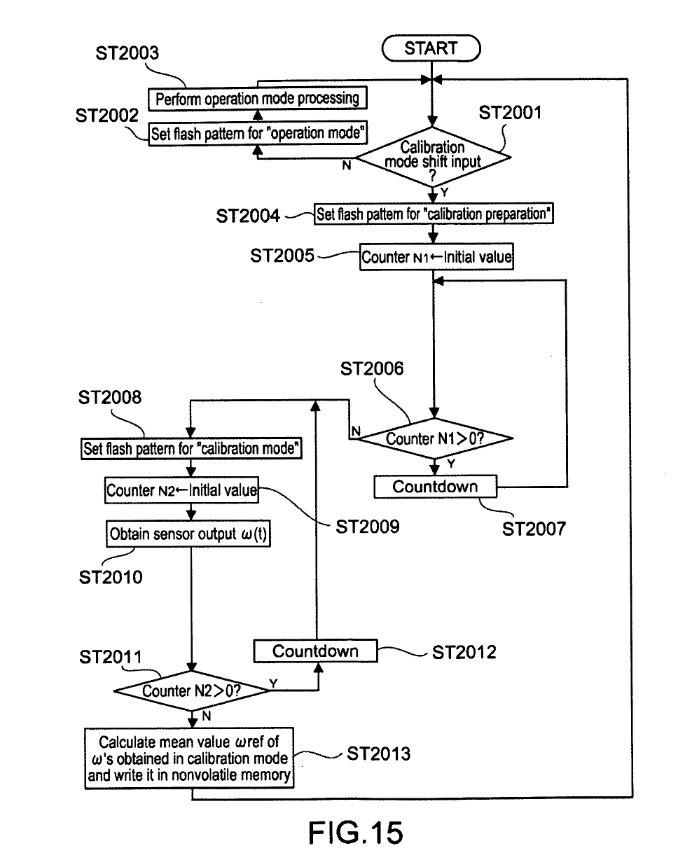

### (Calibration Flow of FIG. 15)

FIG. 15 shows a calibration now of the sensor module according to another embodiment. Contents of processes of Steps 2001 to 2003 in FIG. 15 are the same as those of Steps 1001 to 1003 in FIG. 14. In this example, contents of processes of the calibration preparation mode (Steps 2004 to 2007) are different from those of the calibration preparation mode of FIG. 14 (Steps 1001 to 1009).

The calibration preparation mode of this example ends with only the countdown of the set counter value N1, and is shifted to the calibration processing mode thereafter. In other words, the calibration processing mode is executed assuming that the output of the sensor module becomes static within a predetermined time period since the shift to the calibration mode. Accordingly, an amount of operation required for executing the calibration preparation mode can be reduced, thus simplifying a system structure.

Contents of the calibration processing mode of this example (Steps 2008 to 2013) are the same as those of the calibration processing mode of FIG. 14 (Steps 1010 to 1015). Thus, descriptions thereof will be omitted.

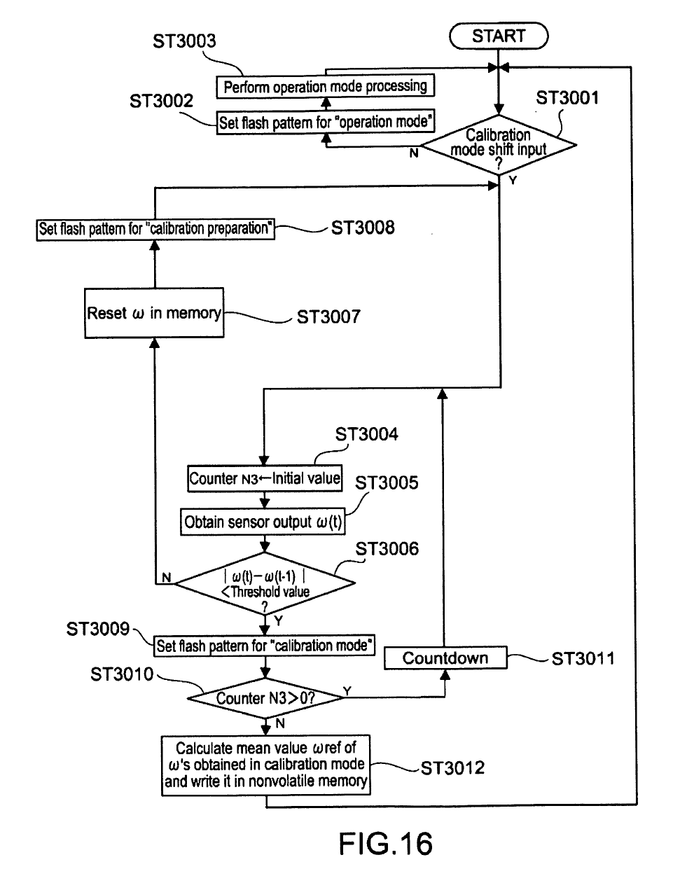

### (Calibration Flow of FIG. 16)

FIG. 16 shows a calibration flow of the sensor module according to still another embodiment. Contents of processes of Steps 3001 to 3003 in FIG. 16 are the same as those of Steps 1001 to 1003 in FIG. 14. This example is different from the calibration flow of FIG. 14 in that the calibration preparation mode and the calibration processing mode are partially integrated. Specifically, in this example, a routine of Steps 3004 to 3008 corresponds to the execution of the calibration preparation mode, and a routine of Steps 3004 to 3006 and 3009 to 3011 corresponds to the execution of the calibration processing mode.

In the calibration mode shown in FIG. 16, first, a predetermined initial counter value N3 is set (Step 3004). Next, an angular velocity value ω(t) is obtained (Step 3005), and the obtained angular velocity value is stored in the memory. Subsequently, a difference (absolute value) between the obtained angular velocity value ω(t) and the previously-obtained angular velocity value ω(t−1) is judged (Step 3006). When the difference is smaller than a certain threshold value Vth2, the mode display lamp 61 of the input apparatus 1 is caused to emit light in the first luminescence pattern for the calibration mode (Step 3009). After that, it is judged whether the counter value N3 has reached 0 (Step 3010). When the counter value N3 has not yet reached 0, the counter value N3 is decremented a predetermined amount (Step 3011) and the process returns to Step 3004.

When the difference between the angular velocity values is equal to or larger than the threshold value Vth2 in Step 3006, it is judged that the angular velocity sensors are not in the static state. Thus, the angular velocity values written in the memory are once reset (deleted) (Step 3007), and the process returns to Step 3004. At this time, it is also possible to cause the mode display lamp 61 to emit light in the luminescence pattern for the calibration preparation mode (restart of calibration) (Step 3008). Moreover, Step 3007 is arbitrary and can be omitted as necessary.

When it is judged that the counter value N3 has reached 0 in Step 3010, a mean value (ωref) of the angular velocity values obtained during a period since the counter value N3 has been set to when the counter value N3 has reached 0 is calculated and stored again in the memory (Step 3012). After the correction value is stored in the memory, the mode display lamp 61 of the input apparatus 1 is caused to emit light in the luminescence pattern for the calibration completion out of the first luminescence pattern as necessary, and the process returns to Step 3001. After that, the same processes as those above are executed again.

The calibration processing of the input apparatus 1 is executed as described above. The example above has described the case where the angular velocity sensor unit 15 is calibrated. However, the acceleration sensor unit 16 can be calibrated by the same method.

### Second Embodiment

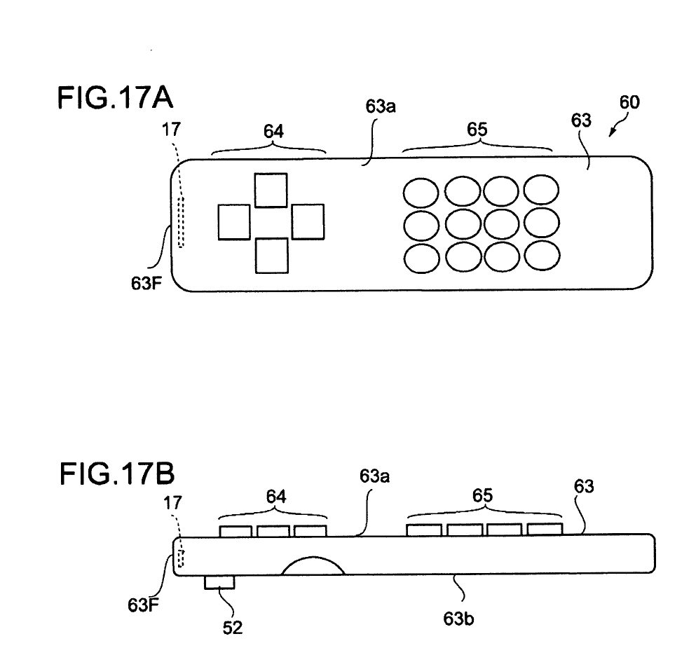

FIG. 17 are diagrams showing a schematic structure of an input apparatus 60 according to a second embodiment, in which FIG. 17A is a plan view and FIG. 17B is a side view thereof.

The input apparatus 60 of this embodiment includes a casing 63 having a configuration shown in the figure. The casing 63 includes a front surface 63a on which a first operation key group 64 including a cursor key button and a second operation key group 65 including a numeric keypad are provided, and a back surface 63b opposed thereto. Inside the casing 63, the control unit 30, the batteries 14 (FIG. 3), the sensor module 17 (FIG. 8), and the like are accommodated as in the first embodiment above. In particular, the sensor module 17 is accommodated at a front end portion 63F of the casing 63. Therefore, by operating the input apparatus 60 such that the front end portion 63F is aimed at the screen, operations of moving the pointer become possible as in the first embodiment above.

The input apparatus 60 of this embodiment is provided with, at a front side of the back surface 63b of the casing 63, a switch 52 for switching the execution of the operation mode to the execution of the calibration mode and vise versa in accordance with the input operation from the outside.

The switch 52 is constituted of a pressure-sensitive sensor, a push-type button, and the like. When the casing 63 is placed on the static support pedestal (support means) such as a table, the switch 52 is turned on by an empty weight of the input apparatus 60, thus switching the input apparatus 60 to the calibration mode. Further, the switch 52 is turned off when the user is operating the input apparatus 60 in the air, thus switching the input apparatus 60 to the operation mode.

In the input apparatus 60 of this embodiment, because the switch 52 for switching the execution of the calibration mode to the execution of the operation mode and vise versa is provided on the back surface side of the casing 63, the calibration mode is prevented from being executed when the user is holding the input apparatus in hand and operating it in the air.

Therefore, according to this embodiment, it is possible to prevent the calibration processing of the sensor module 17 from being executed when the user is holding the input apparatus 60 in hand and operating it in the air. In other words, it becomes possible to reflect the user's intention of using the input apparatus on the detection of the static state of the input apparatus 60, with the result that the detection signals of the sensor module 17 can be corrected appropriately.

On the other hand, when the input apparatus 60 is placed on the support pedestal and is thus released from the hand of the user, the calibration processing of the sensor module 17 is executed by the switch of the switch 52. The execution of the calibration mode is the same as that of the first embodiment described with reference to FIGS. 14 to 16. Thus, descriptions thereof will be omitted.

### Third Embodiment

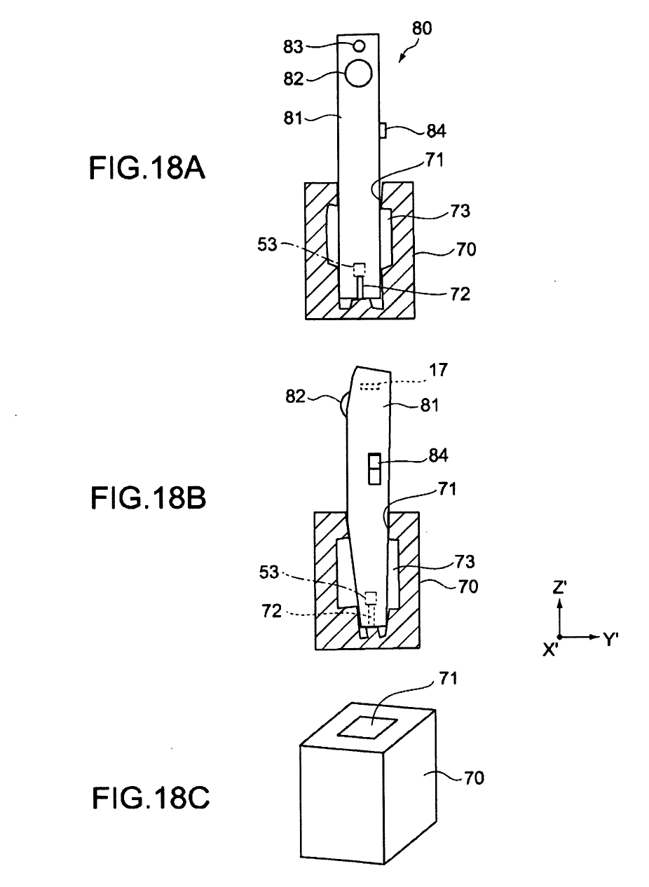

FIG. 18 are diagrams showing a third embodiment. An input apparatus 80 of this embodiment includes a casing 81, a button 82, a mode display lamp 83, a power supply switch 84, and the like. Inside the casing 81, the control unit 30, the batteries 14 (FIG. 3), the sensor module 17 (FIG. 8), and the like are accommodated as in the first embodiment above. In particular, the sensor module 17 is accommodated at a front (upper side in the figures) end portion of the casing 81. Therefore, by operating the input apparatus 80 such that the front end portion of the casing 81 is aimed at the screen, operations of moving the pointer become possible as in the first embodiment above.

The input apparatus 80 of this embodiment is provided with, in the vicinity of a lower (in the figures) end portion of the casing 81, an internal switch 53 for switching the execution of the operation mode to the execution of the calibration mode and vise versa. The internal switch 53 is provided inside the casing 81. By placing or setting the input apparatus 80 on a calibration jig (support means) 70, the operational mode of the input apparatus 80 can be switched between the operation mode and the calibration mode.

The calibration jig 70 is used for calibrating the sensor module 17 and is placed on a stationary horizontal surface. The calibration jig 70 has a rectangular parallelepiped shape as shown in FIG. 18C, and an opening 71 through which the input apparatus 80 is inserted is formed on an upper surface thereof. Inside the calibration jig 70, a space portion 73 that communicates with the opening 71 and accommodates a lower-half portion of the input apparatus 80 is formed. At a bottom of the space portion 73, an operation piece 72 for operating the internal switch 53 by being inserted into the casing 81 when the input apparatus 80 is inserted in the calibration jig 70 is provided as shown in FIGS. 18A and 18B. The execution of the calibration mode of the sensor module 17 is started when the MPU 19 detects that the internal switch 53 has received an input operation by the operation piece 72.

As in the above embodiments, this embodiment is structured to carry out the calibration processing only when the input apparatus is not used. Thus, a highly-accurate calibration can be realized. The calibration jig 70 can also be used as a battery charger (cradle) of the input apparatus 80. It should be noted that a calibration method is the same as that of the first embodiment described with reference to FIGS. 14 to 16. Thus, descriptions thereof will be omitted.

Here, it is of course possible to constitute the internal switch 53 by a push-type switch, but the internal switch 53 may also be constituted of a sensor for optically, electrically, or magnetically detecting an approach of the operation piece 72, or the like. Further, when using the calibration jig 70 also as the battery charger (cradle), the operational mode of the input apparatus may be shifted to the calibration mode with power from the battery charger as a trigger.

Furthermore, the calibration jig 70 is capable of supporting the input apparatus 80 such that the acceleration detection axes of the sensor module 17 become orthogonal to the vertical axis. Therefore, in a state where the input apparatus 80 is placed in the calibration jig 70, the acceleration detection axes (X′ axis and Y′ axis) of the sensor module 17 are orthogonal to a gravity direction. Accordingly, the calibration of the acceleration sensor unit 16 (FIG. 8) can be carried out with high accuracy without being affected by gravity components.

Because the calibration of the acceleration sensors is easily affected by the gravity components, the acceleration sensor unit 16 can only be calibrated by using the dedicated calibration jig 70 as in this embodiment. Accordingly, the acceleration sensors can be prevented from being calibrated unnecessarily, and stable output accuracy of the sensor module 17 can thus be maintained. Based on such an idea, this embodiment may be carried out at a place or by a method with which a user cannot interfere, such as in a manufacturing facility or a maintenance facility of the input apparatus.

Heretofore, the embodiments have been described. However, the present application is not limited to the above embodiments, and various modifications may be added without departing from the gist of the present application.

For example, in the above embodiments, the angular velocity sensors and the acceleration sensors have been used as the sensor to output a potential signal with respect to the reference potential, that corresponds to the movement of the casing. However, in addition to those sensors, a geomagnetic sensor may be used. For example, it is also possible to structure the input apparatus of the present application using the geomagnetic sensor instead of the angular velocity sensor. In this case, the operations of moving the pointer as in the above embodiments can also be realized by structuring the sensor module by combining biaxial or triaxial acceleration sensors and triaxial geomagnetic sensors.

Further, in the above embodiments, the switches 51, 52, and 53 that are operated when the input apparatus is in the static state or the near-static state have been used for switching the operational modes (operation mode and calibration mode) of the input apparatus. However, the present application is not limited thereto.

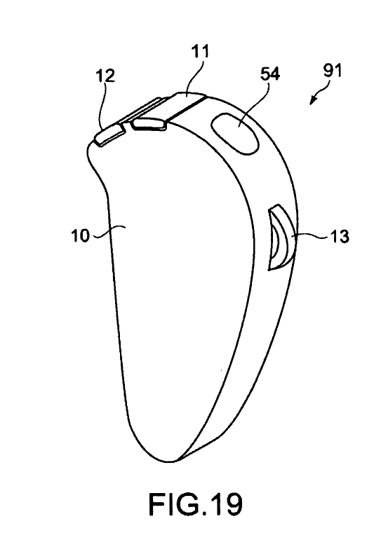

For example, FIG. 19 shows an input apparatus 91 including a switch 54 adjacent to the button 11, for switching operational modes. The input apparatus 91 is structured so that, when the switch 54 is pressed and held for a predetermined time (e.g., 5 sec), the operational mode thereof is switched from the operation mode to the calibration mode. In this case, for securing a preparation time period prior to the start of the calibration mode when the input apparatus is put to the static state by the user, the calibration mode may be started after an elapse of a predetermined time after the operation to the switch 54. Moreover, it is also possible to light up a mode display lamp (not shown) and successively notify the user of the shifts to the calibration preparation mode and the calibration processing mode.

In addition, instead of using the switch 54, the operational mode may be switched to the calibration mode when the buttons 11 and 12 are simultaneously pressed and held, for example.

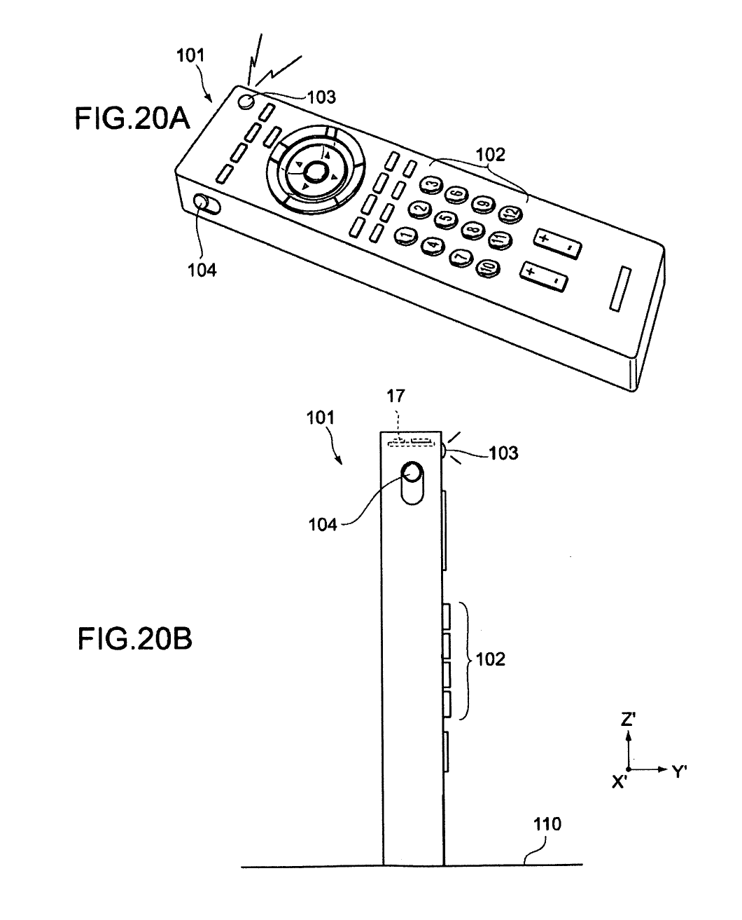

The calibration of the acceleration sensors is not limited to the embodiment that uses the calibration jig 70. For example, in an input apparatus 101 shown in FIG. 20, a switch for switching the operation mode to the calibration mode and vise versa is constituted of two predetermined buttons out of an operation key group 102 and a power switch 104, for example. Specifically, in the input apparatus shown in FIG. 20A, for example, by turning on the power switch 104 while pressing the two buttons, the calibration mode of the input apparatus 101 is executed. After that, by erecting the input apparatus 101 on a static pedestal 110 as shown in FIG. 20B, the acceleration detection axes (X′ axis and Y′ axis) of the sensor module 17 are made orthogonal to the gravity direction. In this state, an appropriate calibration of the acceleration sensors becomes possible. In this case, it is also possible to cause a mode display lamp 103 to emit light in a suitable luminescence pattern so as to notify the progress of the calibration processing.

It should be noted that the buttons to be pressed for shifting the operational mode to the calibration mode and the method of shifting the operational mode to the calibration mode may be set as a “hidden command” known only by specific persons (e.g., workers at manufacturing/managing facilities for input apparatus 101). Accordingly, it becomes possible to prevent unnecessary calibration processing from being carried out by general users.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An input apparatus, comprising:
a casing;
a sensor module that includes a reference potential and outputs, as a detection signal, a fluctuation of a potential with respect to the reference potential, that corresponds to a movement of the casing;
a velocity calculation unit to calculate a pointer velocity value as a velocity value for moving a pointer based on an output of the sensor module;
a first execution means for executing a calibration mode as processing for correcting the reference potential;
a second execution means for executing an operation mode as processing for moving the pointer on a screen in accordance with the pointer velocity value calculated by the velocity calculation unit; and
a switch to switch the execution of the calibration mode to the execution of the operation mode and vise versa in accordance with an input operation from outside.

2. The input apparatus according to claim 1,
wherein the sensor module includes an angular velocity sensor to detect an angular velocity in a rotational direction with a first direction as a center axis.

3. The input apparatus according to claim 2,
wherein the calibration mode includes a calibration preparation mode.

4. The input apparatus according to claim 3,
wherein the switch is a sensor to detect that the input apparatus has been placed on a support means for supporting the input apparatus when the input apparatus is not used, and
wherein the sensor switches the mode to the calibration mode when detecting that the input apparatus has been placed on the support means.

5. The input apparatus according to claim 4,
wherein the sensor module includes a first acceleration sensor to detect an acceleration in a second direction different from the first direction.

6. The input apparatus according to claim 5,
wherein the second direction is orthogonal to a vertical direction when the input apparatus is placed on the support means.

7. The input apparatus according to claim 6,
wherein the sensor module includes a second acceleration sensor to detect an acceleration in the first direction, and
wherein the first direction is orthogonal to the vertical direction when the input apparatus is placed on the support means.

8. The input apparatus according to claim 3,
wherein the casing includes a grip portion, and
wherein the switch is a proximity sensor that is provided at the grip portion and switches the mode to the calibration mode when an output of the proximity sensor corresponds to an output thereof obtained when a user is not holding the grip portion.

9. The input apparatus according to claim 1, further comprising
a notification means for notifying which of the calibration mode and the operation mode is being executed.

10. The input apparatus according to claim 9,
wherein the notification means is a luminescent display means,
wherein the first execution means causes the luminescent display means to emit light in a first luminescence pattern while the calibration mode is being executed, and
wherein the second execution means causes the luminescent display means to emit light in a second luminescence pattern different from the first luminescence pattern while the operation mode is being executed.

11. The input apparatus according to claim 9,
wherein the notification means is a sound generation means,
wherein the first execution means causes the sound generation means to generate sound in a first sound pattern while the calibration mode is being executed, and
wherein the second execution means causes the sound generation means to generate sound in a second sound pattern different from the first sound pattern while the operation mode is being executed.

12. The input apparatus according to claim 1, further comprising
a nonvolatile storage section to store a first correction value obtained by executing the calibration mode.

13. The input apparatus according to claim 12,
wherein the First execution means stores, when a difference between a second correction value obtained by newly executing the calibration mode and the first correction value stored in the storage section is equal to or smaller than a first threshold value, the second correction value in the storage section by replacing the first correction value therewith.

14. The input apparatus according to claim 12,
wherein the first execution means stores, when a second correction value obtained by newly executing the calibration mode is equal to or smaller than a second threshold value, the second correction value in the storage section by replacing the first correction value therewith.

15. The input apparatus according to claim 14,
wherein the first execution means re-executes the calibration mode when the second correction value exceeds the second threshold value, and
wherein the first execution means stores, when a difference between a third correction value obtained by re-executing the calibration mode and the second correction value is equal to or smaller than a third threshold value, one of the second correction value, the third correction value, and a mean value of the second correction value and the third correction value in the storage section by replacing the first correction value therewith.

16. The input apparatus according to claim 1,
wherein the first execution means cancels the execution of the calibration mode when a magnitude of the detection signal exceeds a fourth threshold value while the calibration mode is being executed.

17. A control system, comprising:
an input apparatus including
a casing,
a sensor module that includes a reference potential and outputs, as a detection signal, a fluctuation of a potential with respect to the reference potential, that corresponds to a movement of the casing,
a velocity calculation unit to calculate a pointer velocity value as a velocity value for moving a pointer based on an output of the sensor module,
a transmission unit to transmit the pointer velocity value calculated by the velocity calculation unit,
a first execution means for executing a calibration mode as processing for correcting the reference potential,
a second execution means for executing an operation mode as processing for moving the pointer on a screen in accordance with the pointer velocity value calculated by the velocity calculation unit, and
a switch to switch the execution of the calibration mode to the execution of the operation mode and vise versa in accordance with an input operation from outside; and
a control apparatus including
a reception means for receiving information on the pointer velocity value transmitted from the transmission unit, and
a display control means for controlling a display position of the pointer on the screen in accordance with the pointer velocity value received by the reception means.

18. The control system according to claim 17, further comprising
a notification means for notifying which of the calibration mode and the operation mode is being executed.

19. The control system according to claim 18,
wherein the notification means is a display means for causing display in a first display pattern while the calibration mode is being executed, and causing display in a second display pattern different from the first display pattern while the operation mode is being executed.

20. The control system according to claim 18,
wherein the notification means is a sound generation means for generating sound in a first sound pattern while the calibration mode is being executed, and generating sound in a second sound pattern different from the first sound pattern while the operation mode is being executed.
